(19) United States
(12) Patent Application Publication
(10) Pub. No.: US 2021/0303249 A1
(43) Pub. Date: Sep. 30, 2021

(54) DISPLAY DEVICE AND CONTROL METHOD OF DISPLAY DEVICE

(71) Applicant: SEIKO EPSON CORPORATION, Tokyo (JP)

(72) Inventor: Hitomi Okumura, Shiojiri (JP)

(21) Appl. No.: 17/215,043

(22) Filed: Mar. 29, 2021

(30) Foreign Application Priority Data
Mar. 30, 2020 (JP) 2020-060634

(51) Int. Cl. G06F 3/147

(52) U.S. Cl. CPC G06F 3/147; G06F 3/1293

(57) ABSTRACT

A display device includes a display unit that displays an image, a communication unit that communicates with an external device, and a controller that converts data of a markup language related to a display of the image received from the external device into a control command which is a command that instructs the display of the image to display the image on the display unit based on the control command.

The present application is based on, and claims priority from JP Application Serial Number 2020-060634, filed Mar. 30, 2020, the disclosure of which is hereby incorporated by reference herein in its entirety.

### BACKGROUND

### 1. Technical Field

The present disclosure relates to a display device and a method of controlling the display device.

### 2. Related Art

In the related art, a printing device that receives data written in a markup language from a terminal device, and converts the data into a control command of the printing device is known (see JP-A-2013-210885). A display device such as a display may be further connected to a print control system including the terminal device and the printing device.

However, it is necessary to control the display device after converting the data written in the markup language into a control command via the printing device when controlling the display device from the terminal device using the data written in the markup language. Therefore, when using the data written in the markup language, it is not possible to directly control the display device from an external device such as a terminal device.

### SUMMARY

According to an aspect of the present disclosure, a display device includes a display unit that displays an image, a communication unit that communicates with an external device, and a controller that converts data of a markup language related to a display of the image received from the external device into a control command which is a command that instructs the display of the image to display the image on the display unit based on the control command.

According to an aspect of the present disclosure, in a method of controlling a display device including a display unit that displays an image, and a communication unit that communicates with an external device, the method includes converting data of a markup language related to a display of the image received from the external device into a control command which is a command that instructs the display of the image to display the image on the display unit based on the control command.

### BRIEF DESCRIPTION OF THE DRAWINGS

FIG. 1 is a diagram showing an example of a configuration of a display control system according to an embodiment of the present disclosure.

FIG. 2 is a diagram showing an example of a configuration of an external device according to an embodiment of the present disclosure.

FIG. 3 is a diagram showing an example of a configuration of a display device controller according to an embodiment of the present disclosure.

FIG. 4 is a diagram showing an example of a configuration of a display device according to an embodiment of the present disclosure.

FIG. 5 is a diagram showing an example of an image display process according to an embodiment of the present disclosure.

FIG. 6 is a diagram showing an example of parameters in a control command that specifies a mode of a font according to an embodiment of the present disclosure.

FIG. 7 is a diagram showing an example of a screen according to an embodiment of the present disclosure.

FIG. 8 is a diagram showing an example of an image display process including a display switching mode according to an embodiment of the present disclosure.

FIG. 9 is a diagram showing an example of parameters in a control command that specifies a display switching mode setting according to an embodiment of the present disclosure.

FIG. 10 is a diagram showing an example of parameters in a control command that specifies a display switching mode setting according to an embodiment of the present disclosure.

FIG. 11 is a diagram showing an example of a screen displayed in the display switching mode according to an embodiment of the present disclosure.

FIG. 12 is a diagram showing an example of a screen displayed in the display switching mode according to an embodiment of the present disclosure.

FIG. 13 is a diagram showing an example of a screen displayed in the display switching mode according to an embodiment of the present disclosure.

### DESCRIPTION OF EXEMPLARY EMBODIMENTS

### Embodiments

Hereinafter, embodiments of the present disclosure will be described in detail with reference to the drawings. FIG. 1 is a diagram showing an example of the configuration of a display control system 1 according to the present embodiment. The display control system 1 includes an external device 2, a display device 3, a printing device 4, and a Web application server 5. The external device 2 and the Web application server 5 are connected to each other via a network such as the Internet. The external device 2, the display device 3, and the printing device 4 are connected to each other via a network such as a wireless LAN. The external device 2 is, for example, a tablet terminal, carried by a clerk at a retail store, with which the clerk introduces a product to a customer. The display device 3 is, for example, a display device, including a display, which is installed in a retail store. The printing device 4 is, for example, a receipt printer that issues an accounting receipt. The external device 2, the display device 3, and the printing device 4 may be connected to each other via a network such as a wired LAN.

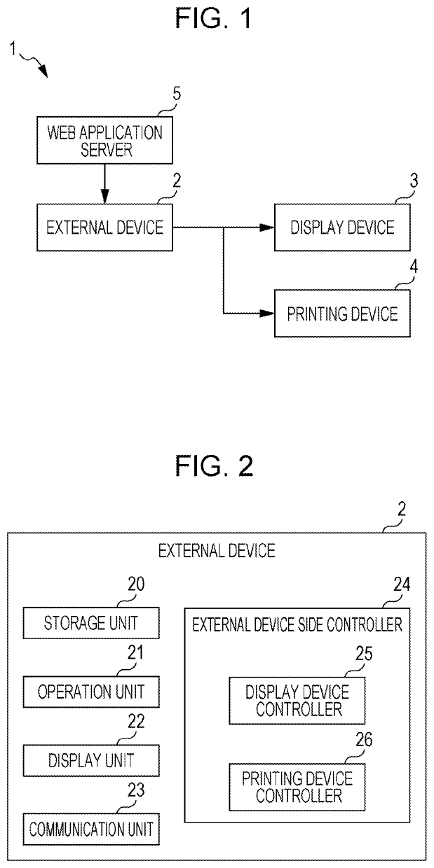

Here, the configuration of the external device 2 will be described with reference to FIG. 2. FIG. 2 is a diagram showing an example of the configuration of the external device 2 according to the present embodiment. The external device 2 includes a storage unit 20, an operation unit 21, a display unit 22, a communication unit 23, and an external device side controller 24.

The storage unit 20 stores information. The information stored in the storage unit 20 includes a Web browser. The storage unit 20 is configured by, for example, a storage device such as a magnetic hard disk device or a semiconductor storage device. The storage unit 20 may be described as a memory.

The communication unit 23 communicates with each of the display device 3, the printing device 4, and the Web application server 5. The communication unit 23 is configured by communication hardware according to a predetermined communication standard. Examples of the communication hardware include hardware such as a communication circuit, a communication port, a communication board, and a communication connector. Here, the communication unit 23 performs communication with the Web application server 5 based on a hypertext transfer protocol (HTTP). The communication unit 23 transmits the HTTP request to the Web application server 5 and receives, based on the uniform resource locator (URL) included in this HTTP request, a Web page provided by the Web application server 5.

A page control script (Javascript (registered trademark)) for controlling the Web page itself, a print control script (Javascript (registered trademark)) for performing print control, or a display control script (Javascript (registered trademark)) for performing display control is embedded in this web page incorporates.

The display unit 22 displays the Web page. The display unit 22 displays the Web page acquired by the Web browser on the Web browser, and displays various notification screens or various setting screens associated with the operation of the Web browser. The display unit 22 may be described as a display.

The operation unit 21 receives an operation from the user of the external device 2. This operation includes, in the Web page displayed on the display unit 22, the operation of displaying the information included in the Web page on the display device 3 and the operation of printing the information included in the Web page on the printing device 4. As an example, the operation unit 21 and the display unit 22 are integrally configured including a touch panel. The operation unit 21 and the display unit 22 may be separately configured.

Here, for example, the Web page includes an image of an advertisement for a product to be displayed on a display installed in a retail store. When the image of the advertisement included in the Web page is clicked, and the operation of displaying the image of the advertisement on the display device 3 is accepted, the display control script embedded in the web page is executed, and display data for displaying this image is transmitted to the display device 3. The display data will be described later. When the Web application is a POS application, the barcode reading result or the accounting result is displayed as a Web page. The barcode reading result includes, for example, a product name, a unit price, quantity, and the like of a purchased product. Further, a print instruction is given to the printing device 4 by touching the “accounting” form provided on the Web page. Pressing the “accounting key” is an example of an operation that the operation unit 21 receives from the user.

The function of the external device side controller 24 is implemented by, for example, a central processing unit (CPU) and performs various processes. The external device side controller 24 includes a display device controller 25 and a printing device controller 26. The external device side controller 24 may be simply described as a processor. The display device controller 25 transmits the markup language data related to the display of the image to the display device 3 to display the image on the display device 3. The printing device controller 26 transmits the markup language data related to printing to the printing device 4 to cause the printing device 4 to perform printing.

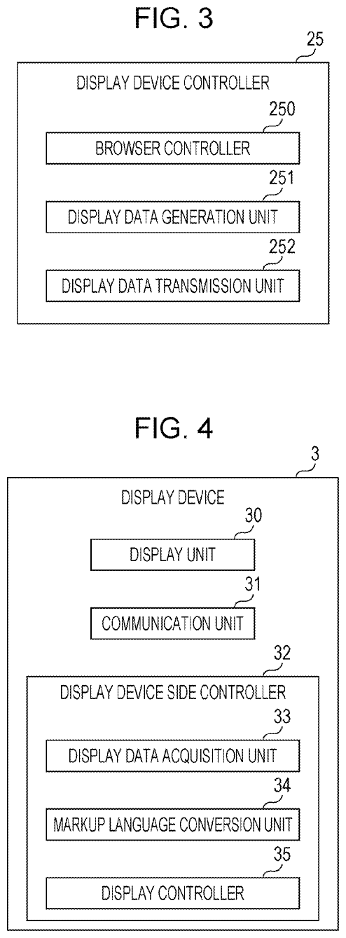

Next, the configuration of the display device controller 25 will be described with reference to FIG. 3. FIG. 3 is a diagram showing an example of the configuration of the display device controller 25 according to the present embodiment. The display device controller 25 includes a browser controller 250, a display data generation unit 251 and a display data transmission unit 252.

The browser controller 250 operates a Web browser. The browser controller 250 executes a Web browser stored in the storage unit 20 to display, on the display unit 22, the Web page acquired from the Web application server 5 via the communication unit 23.

The display data generation unit 251 generates display data described in the XML language by using a display control script that operates on the Web browser. That is, the display data is markup language data related to the display of an image. The display data includes information that indicates a control command, which is a command that instructs the display of an image, and that is described in the markup language. In the following description, the information indicating the control command described and included in the display data in the markup language may be referred to as control command specification information.

The control commands include for example, a control command that specifies the mode of a font included in an image, a control command that specify or cancel the window in the text area, a control command that specifies screen brightness, a control command scrolling by which the image is moved from a first display position to a second display position, a control commands that specifies the contrast of the image, a control commands that specifies one or a plurality of images, a control command related to a display switching mode, and the like.

The display data transmission unit 252 transmits the display data generated by the display data generation unit 251 to the display device 3.

Next, the configuration of the display device 3 will be described with reference to FIG. 4. FIG. 4 is a diagram showing an example of the configuration of the display device 3 according to the present embodiment. The display device 3 includes a display unit 30, a communication unit 31, and a display device side controller 32.

The display unit 30 displays an image. The display unit 30 is configured by a display such as a liquid crystal display or an organic electroluminescence (EL) display as an example. The display unit 30 displays an image on the display. The image displayed by the display unit 30 includes an image of a product, an image of a font, and the like.

The communication unit 31 communicates with the external device 2. The communication unit 31 is configured by communication hardware according to a predetermined communication standard. Examples of the communication hardware include hardware such as a communication circuit, a communication port, a communication board, and a communication connector. The function of the display device side controller 32 is implemented by, for example, a CPU, and performs control for displaying an image. The display device side controller 32 includes a display data acquisition unit 33, a markup language conversion unit 34, and a display controller 35.

The display data acquisition unit 33 acquires the display data received from the external device 2. The markup language conversion unit 34 converts the display data acquired by the display data acquisition unit 33 into a control command. The control command is a command that instructs the display of an image. The display controller 35 displays the image on the display unit 30 based on the control command converted from the display data by the markup language conversion unit 34.

### Image Display Process

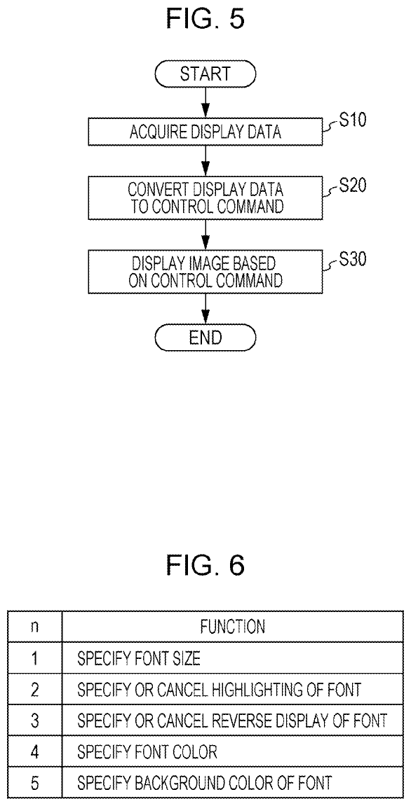

Here, with reference to FIG. 5, an image display process, which is a process in which the display device 3 display an image, will be described. FIG. 5 is a diagram showing an example of the image display process according to the present embodiment.

In step S10, the display data acquisition unit 33 acquires the display data. Here, the display data is received from the external device 2 through the communication unit 31. The display data acquisition unit 33 supplies the acquired display data to the markup language conversion unit 34.

In step S20, the markup language conversion unit 34 converts the display data acquired by the display data acquisition unit 33 into a control command. Here, the markup language conversion unit 34 converts the display data into a control command by converting the control command information included in the display data into a control command. The markup language conversion unit 34 supplies the converted control command to the display controller 35.

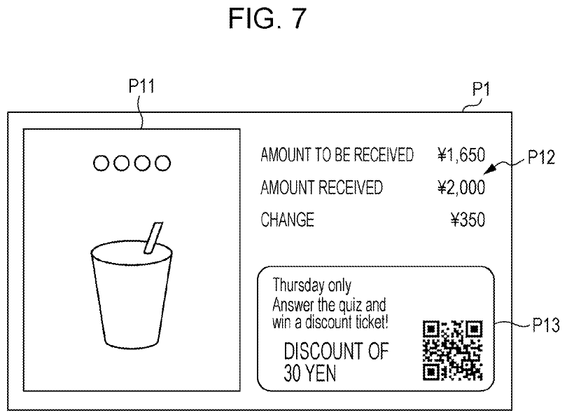

In step S30, the display controller 35 displays the image on the display unit 30 based on the control command converted from the display data by the markup language conversion unit 34. FIG. 7 shows an example of an image displayed by the display unit 30. In the example shown in FIG. 7, an image P11, an image P12, and an image P13 are displayed on a screen P1. The image P11 shows an image of an advertisement for a product. The image P12 shows an accounting content. The image P13 shows discount information and the like. With the above, the display device 3 ends the image display process.

A specific example of the control command will be described here. The control command includes, for example, a control command that specifies the mode of a font included in the image. The control command is represented by, for example, “XYZ (A B C n D E”. Here, the contents indicated by the control command differs depending on the value of “n”. FIG. 6 shows an example of the correspondence between the value of the parameter “n” and the contents instructed by the control command. When “n” is “1” in the control command information, the control command specifies the font size of the font in the image. When “n” is “2”, the control command specifies or cancels highlighting of the font in the image. When “n” is “3”, the control command specifies or cancels the reverse display of the font in the image. When “n” is “4”, the control command specifies the font color of the font in the image. When “n” is “5”, the control command specifies the background color of the font. In addition, “to specify” may be described as “to instruct”.

As another example, the control command includes a control command that specifies scrolling by which the image is moved from the first display position to the second display position. The control command that specifies scrolling causes the image to move in the vertical or horizontal direction, for example, by a predetermined movement amount within the screen. The control command is represented by, for example, “XYZ M1” or “XYZ M2”. “XYZ M1” is converted into a control command that specifies scrolling in the vertical direction. “XYZ M2” is converted into a control command that specifies scrolling in the horizontal direction. The vertical direction may be described as the up and down direction, and the horizontal direction may be described as the right and left direction. Further, the vertical direction may be orthogonal to or intersecting the horizontal direction.

The control command of “XYZ M1” moves, for example, the display position of the displayed image to the lower left end when the display position of the displayed image is at the upper right end of the screen. On the other hand, when the display position of the displayed image is at the lower right edge of the screen, this control command scrolls the displayed lower image to the upper and clears the image displayed at the bottom. For example, when the display position of the displayed image is at the right end, the control command of “XYZ M2” scrolls all the images displayed on the line with the cursor to the left by a predetermined amount of movement, and displays the newly received image at the right end of the scrolled image.

### Display Switching Mode

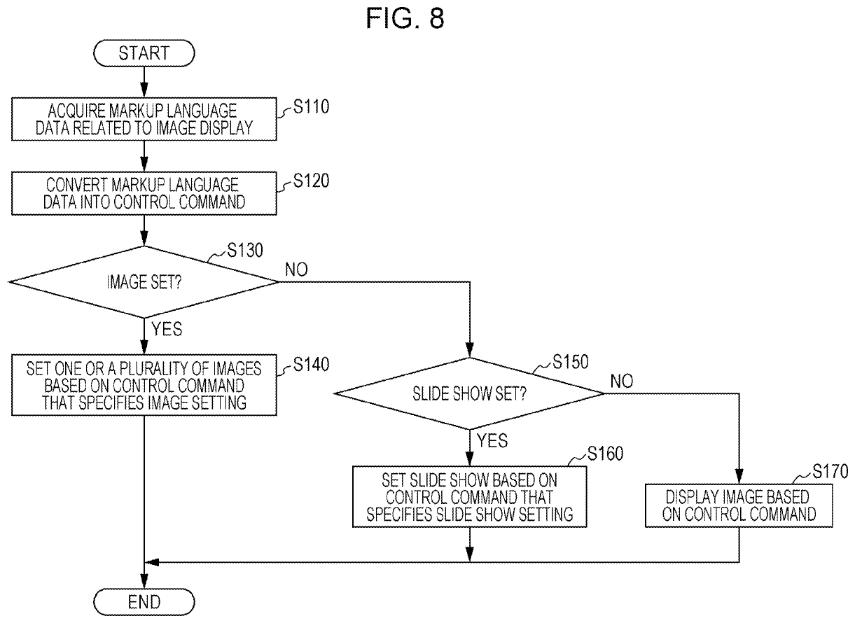

The display device 3 may display a plurality of images by using a display switching mode in which a plurality of images is switched and displayed according to the passage of time. The display switching mode will be described below with reference to FIGS. 8 to 13. The display switching mode is also referred to as a slide show. FIG. 8 is a diagram showing an example of an image display process including a display switching mode according to the present embodiment. Since the processes of step S110, step S120, and step S170 are the same as the processes of step S10, step S20, and step S30 in FIG. 5, the explanation is omitted.

In step S130, the display controller 35 determines whether to set an image. Here, the display controller 35 makes a determination based on the control command that specifies an image setting among the control commands converted from the display data by the markup language conversion unit 34. When the display controller 35 determines that the control command is a control command that specifies the image setting (step S130; YES), the display controller 35 executes the process of step S140. On the other hand, when the display controller 35 determines that the control command is not a control command that specifies the image setting (step S130; NO), the display controller 35 executes the process of step S150.

In step S140, the display controller 35 sets one or a plurality of images based on the control command that specifies the image setting. More specifically, the display controller 35 registers one or a plurality of images included in the control command that specifies the image setting in a storage unit such as a nonvolatile memory.

In step S150, the display controller 35 determines whether to set a slide show. Here, the display controller 35 makes a determination based on the control command that specifies a slide show setting among the control commands converted from the display data by the markup language conversion unit 34. When the display controller 35 determines that the control command is a control command that specifies the slide show setting (step S150; YES), the display controller 35 executes the process of step S160. On the other hand, when the display controller 35 determines that the control command is not a control command that specifies the slide show setting (step S150; NO), the display controller 35 executes the process of step S170.

In step S160, the display controller 35 sets the slide show based on the control command that specifies the slide show setting. More specifically the display controller 35 sets, based on a control command that specifies the slide show setting, the image layout to be displayed on the display unit 30, the start or end of the slide show, and the image switching time. The display controller 35 may register, in the storage unit, the slide show setting information included in the control command that specifies the slide show setting. With the above, the display device 3 ends the image display process including the display switching mode. Some processes may be omitted from the processes from step S110 to step S170, or the order of some processes may be changed.

Here, a specific example of the control command that specifies the image setting will be described. This control command is represented by, for example, “XYZ (U A B n C D E F”. Further, the control command that specifies the slide show setting is represented by “XYZ (U A B n m” as an example.

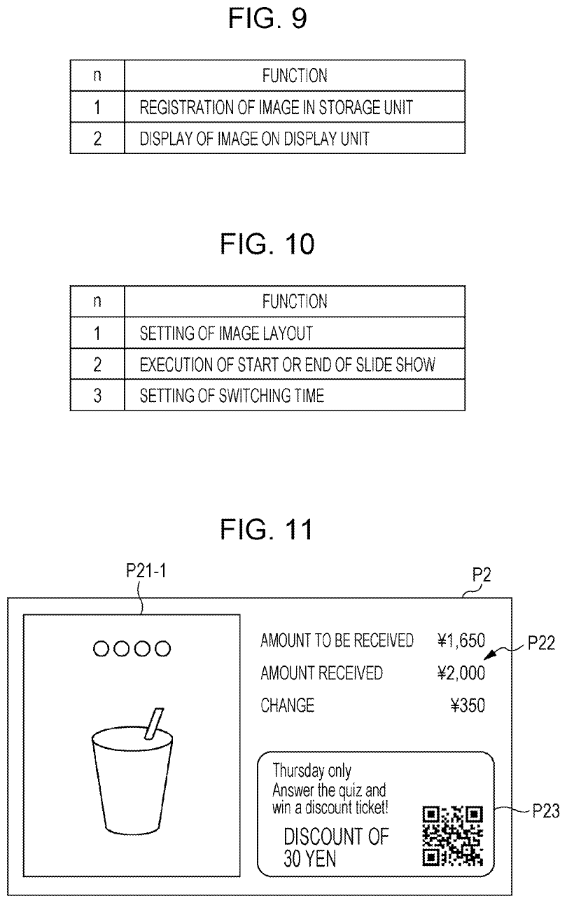

As shown in FIG. 9, for example, when “n” is “1”, the control command that specifies the image setting is a control command that specifies the registration of one or a plurality of images in the storage unit. When “n” is “1”, the above-mentioned control command is represented by, for example, “XYZ (U A B 1 C D E F”. “C”, “D”, and “E” are values that specify the storage location of one or a plurality of images. “F” is image data of one or a plurality of images. When “n” is “2”, the control command described above may be a control command that specifies the display of one or a plurality of images on the display unit 30.

As shown in FIG. 10, the control command that specifies the slide show settings is a control command that specifies the setting of an image layout to be displayed on the display unit 30, for example, when “n” is “1”. When “n” is “2”, this control command is a control command that specifies the setting of the start or end of the slide show. When “n” is “3”, this control command is a control command that specifies the setting of the image switching time.

When “n” is “1”, the control command described above is represented by, for example, “XYZ (U A B 1 m”, and is a control command that specifies the setting of the image layout to be displayed on the display unit 30. At this time, “m” is a value that specifies the screen mode of the display unit 30. For example, when “m” is 1, a screen mode in which the screen is divided into left and right portions and the image is displayed on either or both of the left and right portion is set, and when “m” is 2, a screen mode in which the screen is divided into upper and lower portions and the image is displayed on either or both of the upper and lower portions is set. When “n” is “2”, the control command described above is represented by, for example, “XYZ (U A B 2 m”, and is a control command that specifies the start or end setting of the slide show. At this time, “m” is a value that specifies the start or end of the slide show. For example, when “m” is 1, the control command is a control command to specify the start of the slide show, and when “m” is 2, the control command is a control command that specifies the end of the slide show. When “n” is “3”, the above-mentioned control command is represented by, for example, “XYZ (U A B 3 m”, and is a control command that specifies the setting of the image switching time. At this time, “m” is a value that specifies the switching time of the slide show. For example, when “m” is 1, the display time of one image is one second. When “m” is 1, the display time is not limited to one second, but another display time may be calculated and used.

The control command that specifies the slide show settings may include a value that specifies the image used for the slide show. For example, a value for specifying the storage location of one or a plurality of images registered in the storage unit by the control command that specifies the image setting may be included in the control command that specifies the slide show setting. Further, the control command that specifies the slide show setting may be a control command that specifies the image switching order.

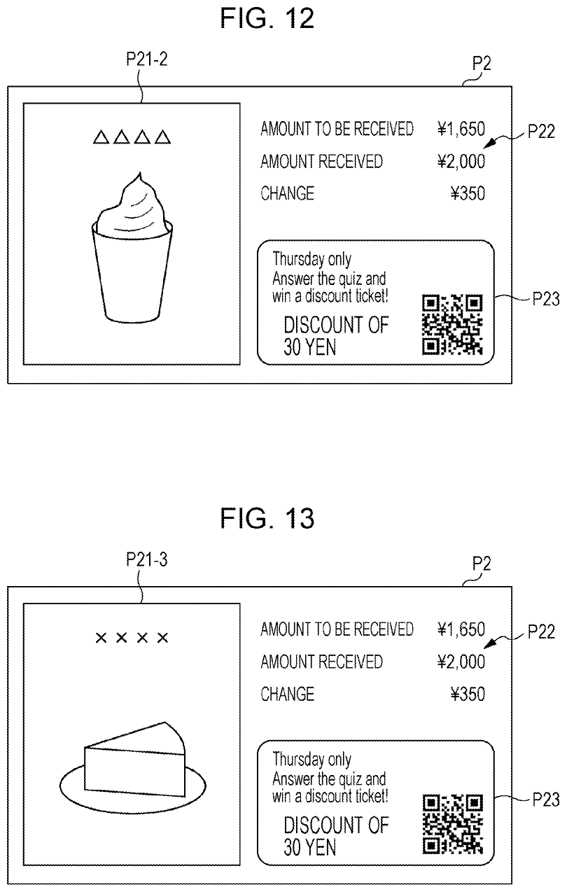

FIGS. 11 to 13 are diagrams showing an example of a screen displayed by the display unit 30 in the display switching mode according to the present embodiment. In the example shown in FIG. 11, an image P21-1, an image P22, and an image P23 are displayed on a screen P2. The image P21-1 shows an image of an advertisement for a product. The image P22 shows an accounting content. Image P23 shows discount information and the like. Here, the display controller 35 switches the image P21-1 shown in FIG. 11 to the image P21-2 shown in FIG. 12 and the image P21-3 shown in FIG. 13 according to the passage of time. The display controller 35 displays the image P21-1 again after the image P21-3. Hereinafter, in the same manner, the image P21-1, the image P22-2, and the image P23-3 are switched in this order according to the passage of time. That is, the image of the advertisement of the product is switched on the screen P2 according to the passage of time.

In the present embodiment, an example in which the display control system 1 includes one display device 3 and one printing device 4 is described, but the present disclosure is not limited to this. The display control system 1 may include a plurality of display devices or a plurality of printing devices. Further, the display control system 1 may not include the printing device 4. Further, in the present embodiment, an example in which the display control system 1 includes the Web application server 5 is described, but the present disclosure is not limited to this. The display control system 1 may not include the Web application server 5. In this case, the storage unit 20 provided in the external device 2 stores the Web page.

As described above, the display device 3 according to the present embodiment includes the display unit 30, the communication unit 31, and the controller. The display unit 30 displays an image. The communication unit 31 communicates with the external device 2. The controller converts the markup language data related to the display of the image received from the external device 2 into the control command which is a command that instructs the display of the image to display the image on the display unit 30 based on the control command. Here, the display device side controller 32 is an example of the controller.

With this configuration, the display device 3 according to the present embodiment can convert the markup language data related to the display of the image into the control command which is a command that instructs the display of the image, so that when controlling a using data written in a markup language the display device can be controlled directly from an external device.

Part of the display device 3 in the above-described embodiment, for example, the display data acquisition unit 33, the markup language conversion unit 34, and the display controller 35 may be achieved by a computer. In this case, a program for implementing the control function may be recorded in a computer-readable recording medium, and the program recorded in the recording medium may be loaded into a computer system and the program may be executed. The “computer system” referred to here is a computer system built in the display device 3, and includes an OS and hardware such as a peripheral device. The “computer-readable recording medium” is a portable medium such as a flexible disk, a magneto-optical disk, a ROM or a CD-ROM, or a storage device such as a hard disk built in the computer system. Furthermore, the “computer-readable recording medium” may include a medium that holds a program dynamically for a short time, such as a communication line when the program is transmitted via a network such as the Internet or a communication line such as a telephone line, or a medium that holds a program for a certain period of time, such as a volatile memory in the computer system that is the server or client in the above case. Further, the above program may implement part of the above-mentioned functions, and further, the above-mentioned functions may be implemented in combination with programs already recorded in the computer system. Further, part or all of the display device 3 in the above-described embodiment may be achieved by an integrated circuit such as a large scale integration (LSI). The functional blocks of the display device 3 may be implemented by respective processors, or part or all of them may be integrally implemented by a processor. Further, the circuit integration is not limited to be implemented by an LSI, but may be implemented by a dedicated circuit or a general-purpose processor. Further, when a circuit integration technique that replaces the LSI become a reality due to an advance in semiconductor technology, an integrated circuit based on this technique may be used.

Although an embodiment of this disclosure is described in detail with reference to the drawings, the specific configuration is not limited to the above. It is possible to make various design changes to the extent that it does not deviate from the gist of this disclosure.

What is claimed is:

1. A display device comprising: a display unit that displays an image;
a communication unit that communicates with an external device; and
a controller that converts data of a markup language related to a display of the image received from the external device into a control command which is a command that instructs the display of the image to display the image on the display unit based on the control command.

2. The display device according to claim 1, wherein
the control command includes a control command that specifies whether to set a mode to a display switching mode in which a plurality of images is switched and displayed according to a passage of time.

3. The display device according to claim 2, wherein
the control command includes a control command that specifies the plurality of images, an order in which the plurality of images is switched, and timing at which the plurality of images is switched.

4. The display device according to claim 1, wherein
the control command includes a control command that specifies a mode of a font included in the image.

5. The display device according to claim 1, wherein
the control command includes a control command that specifies scrolling by which the image is moved from a first display position to a second display position.

6. A method of controlling a display device including a display unit that displays an image, and a communication unit that communicates with an external device, the method comprising:
converting data of a markup language related to a display of the image received from the external device into a control command which is a command that instructs the display of the image to display the image on the display unit based on the control command.
